(19) United States
(12) Patent Application Publication
(10) Pub. No.: US 2008/0036313 A1
(43) Pub. Date: Feb. 14, 2008

(54) Fan, motor and magnetic conducting housing thereof

(75) Inventors: Chen-Mo Jiang, Taoyuan Hsien (TW); Chung-Kai Lan, Taoyuan Hsien (TW); Lee-Long Chen, Taoyuan Hsien (TW); Hung-Chi Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/878,103

(22) Filed: Jul. 20, 2007

(30) Foreign Application Priority Data
Aug. 14, 2006 (TW) 095129723

(51) Int. Cl. H02K 1/28

(52) U.S. Cl. 310/46; 310/89

(57) ABSTRACT

A magnetic conducting housing of a motor includes a body and at least one first positioning structure. The magnetic conducting housing has a magnetic element disposed around an inner wall thereof. The body has a top surface and a side wall connected with a circumference of the top surface to form an opening. The first positioning structure extends from the side wall of the body and is close to the opening for holding the magnetic element. Also, a motor and a fan with above-mentioned magnetic conducting housing are disclosed.

### CROSS REFERENCE TO RELATED APPLICATIONS

This Non-provisional application claims priority under 35 U.S.C. §119(a) on Patent Application No(s). 095129723, filed in Taiwan, Republic of China on Aug. 14, 2006, the entire contents of which are hereby incorporated by reference.

### BACKGROUND OF THE INVENTION

1. Field of Invention

The present invention relates to a fan, a motor, and the magnetic conducting housing thereof. In particular, the present invention relates to a fan, a motor, and their magnetic conducting housing that can effectively position magnetic elements.

2. Related Art

In the information era, electronic products have become an indispensable part of daily life or office tools. Motors are widely used in such products for converting electrical energy to mechanical energy.

As shown in FIG. 1, a conventional motor 1 includes an iron housing 10, a rotor 11, and a stator 12. The rotor 11 has a shaft 111 and a magnetic strip 112. The shaft 111 is connected to the iron housing 10 and penetrates through a hole 13 on the motor 1. The magnetic strip 112 is disposed around the inner surface of the iron housing 10. The stator 12 has several coil sets 121 disposed corresponding to the magnetic strip 112 of the rotor 11. The magnetic interaction between the coil sets 121 and the magnetic strip 112 generates an alternating magnetic field that drives the rotor 11 to rotate.

Generally speaking, the magnetic strip 112 and the iron housing 10 are combined by first applying anaerobic glue on the inner surface of the iron housing 10, following by adhering the magnetic strip 112 onto it. However, anaerobic glue is likely to deteriorate after long-time use or in a high-temperature environment. In that case, the magnetic strip 112 may misalign or even depart from the iron housing 10. Besides, considering that the iron housing 10 does not have any structure to position the magnetic strip 112, and it is necessary to spend extra time and care on positioning the magnetic strip 112 during the assembly. As the results, the efficiency is decreased.

Therefore, it is an important subject to provide a fan, a motor, and their magnetic conducting housing that can effectively position the magnetic strip in order to prevent misalignment or departure of the magnetic strip after long-time use.

### SUMMARY OF THE INVENTION

The present invention is to provide a magnetic element, used in a fan, motor and the magnetic conducting housing thereof, that can be effectively positioned and avoid misalignment or departure.

The present invention discloses a magnetic conducting housing for a motor. A magnetic element is disposed around an inner surface of the magnetic conducting housing. The magnetic conducting housing includes a body and at least one first positioning structure. The body has a top surface and a side wall connected with a circumference of the top surface to form an opening. The first positioning structure extends from the side wall of the body and is close to the opening for holding the magnetic element.

The present invention also discloses a motor including a stator, a rotor and a magnetic conducting housing. The rotor has a magnetic element disposed corresponding to the stator. The magnetic conducting housing includes a body and at least one first positioning structure. The body has a top surface and a side wall connected with a circumference of the top surface to form an opening. The magnetic element is disposed around an inner surface of the side wall. The first positioning structure extends from the side wall of the body and is close to the opening for holding the magnetic element.

The present invention further discloses a fan including an impeller and a motor connected to and driving the impeller to rotate. The motor includes a stator, a rotor and a magnetic conducting housing. The rotor has a magnetic element disposed corresponding to the stator. The magnetic conducting housing includes a body and at least one first positioning structure. The body has a top surface and a side wall connected with a circumference of the top surface to form an opening. The magnetic element is disposed around an inner surface of the side wall. The first positioning structure extends from the side wall of the body and is, close to the opening for holding the magnetic element.

In the fan, motor and magnetic conducting housing of the present invention, the first positioning structure is disposed along a circumference of the side wall and extends inwardly. Alternatively, the first positioning structure has a predetermined angle with respect to the side wall, and the magnetic element has at least one cutting angle corresponding to the predetermined angle. Furthermore, the magnetic conducting housing of the present invention may includes a plurality of first positioning structures, which are a plurality of hooks formed along the circumference of the opening for holding the magnetic element. Alternatively, the first positioning structure can be formed by directly indenting the side wall or bending the side wall inwardly.

As mentioned above, the fan, the motor and the magnetic conducting housing thereof have a positioning structure disposed along a circumference of the magnetic conducting housing. Such a positioning structure can be formed along the side wall or by indenting the side wall, achieving the goal of holding the magnetic element. In comparison with the prior art, the disclosed positioning structures can indeed provide the positioning function and increase the assembly efficiency. Moreover, the present invention can prevent misalignment or department of the magnetic element after long-time use.

### BRIEF DESCRIPTION OF THE DRAWINGS

The present invention will become more fully understood from the detailed description given herein below illustration only, and thus is not limitative of the present invention, and wherein:

FIG. 1 is a schematic view of a conventional motor;

FIG. 2 is a schematic view of a fan according to an embodiment of the present invention;

FIGS. 3, 4 and 6 are schematic views showing three magnetic conducting housings in FIG. 2;

FIG. 5 is a cross-sectional view showing the magnetic conducting housing and the magnetic element in FIG. 4 along line A-A′;

FIGS. 7A and 8A are another two magnetic conducting housings having the first and second positioning structures according to the present invention;

FIG. 7B shows a partial cross-section along line C-C′ in FIG. 7A; and

FIG. 8B shows another partial cross-section along line D-D′ in FIG. 8A.

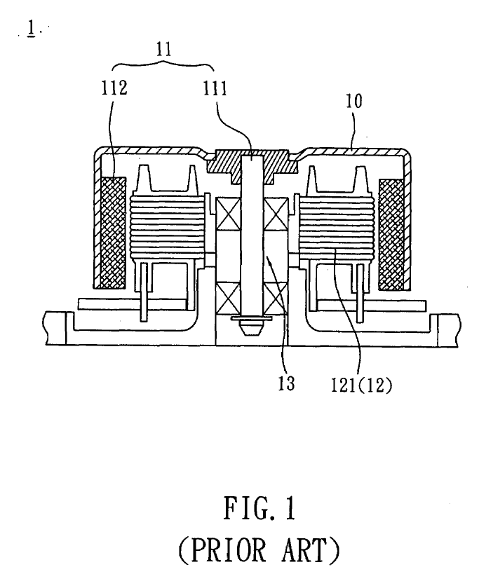

### DETAILED DESCRIPTION OF THE INVENTION

The present invention will be apparent from the following detailed description, which proceeds with reference to the accompanying drawings, wherein the same references relate to the same elements.

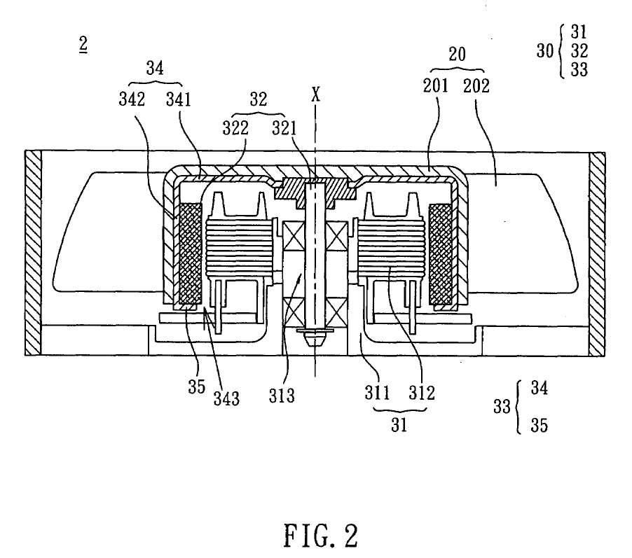

As shown in FIG. 2, the fan 2 according to an embodiment of the present invention includes an impeller 20 and a motor 30. This embodiment uses an axial-flow fan 2 as an example. The same can be applied to a centrifugal fan as well. The impeller 20 includes a hub 201 and several blades 202 disposed around the hub 201.

This embodiment uses an outer-rotor motor 30 as an example, and the motor 30 includes a stator 31, a rotor 32, and a magnetic conducting housing 33. The magnetic conducting housing 33 includes a body 34 and at least one first positioning structure 35. The body 34 has a top surface 341 and a side wall 342 connected with a circumference of the top surface 341 to form an opening 343. The first positioning structure 35 extends from the side wall 342 of the body 34 and is close to the opening 343. The magnetic conducting housing 33 in this embodiment is an iron housing.

The rotor 32 includes a shaft 321 and a magnetic element 322, and the shaft 321 is connected to the magnetic conducting housing 33. The magnetic element 322 is an annular magnetic strip or an annular permanent magnet disposed on an inner surface of the side wall 342 of the magnetic conducting housing 33. When the fan 2 operates, the first positioning structure 35 of the magnetic conducting housing 33 holds one end of the magnetic element 322. The hub 201 is disposed outside the magnetic conducting housing 33.

The stator 31 includes a tube 311 and a stator magnetic pole 312. The tube 311 has a hole 313. The shaft 321 of the rotor 32 is inserted into the tube and pivotally through the hole 313. The stator magnetic pole 312 is consisted by at least one coil set and is disposed opposite to the magnetic element 322. The interaction between their magnetic fields produces a relative motion between the rotor 32 and the stator 31. The impeller 20 with the blades 202 thus rotates to generate airflow.

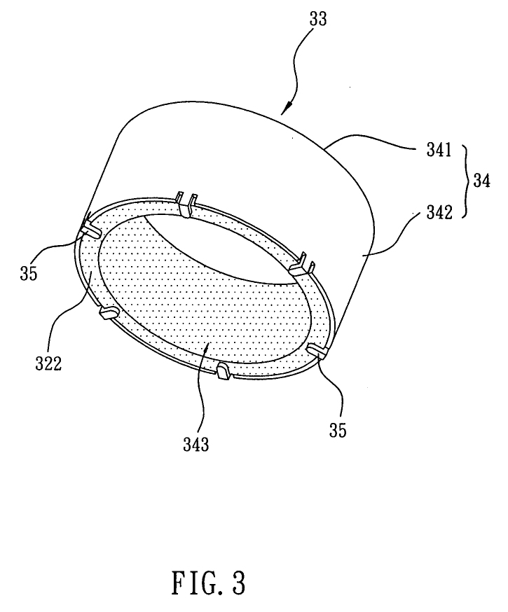

As shown in FIG. 3, several first positioning structures 35 can be integrally formed along the circumference of the side wall 342 of the body 34. That is, several first positioning structures 35 are close to the opening 343 and extend inwardly to form as a L shape. However, the present invention is not limited to this example. The first positioning structures 35 and the body 34 can be two separate components to be combined.

In this embodiment, each first positioning structure 35 is a hook. After the magnetic element 322 is disposed close to the inner surface of the side wall 342 of the magnetic conducting housing 33, an external force is imposed to bend the side wall inwardly to form the first positioning structure 35. That is, the first positioning structure 35 is bent inwardly and towards a hypothetical axle X. The first positioning structure 35 is thus perpendicular with respect to the side wall 342 of the body 34. Therefore, the magnetic element 322 is restricted and positioned at the same time inside the magnetic conducting housing 33. Additionally, an adhesive glue can be used to enhance combination effect. The first positioning structure 35 has a semicircular, semielliptical, triangular, or polygonal profile.

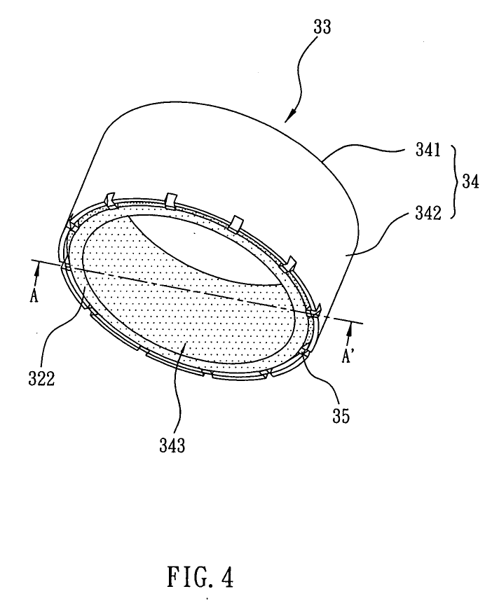

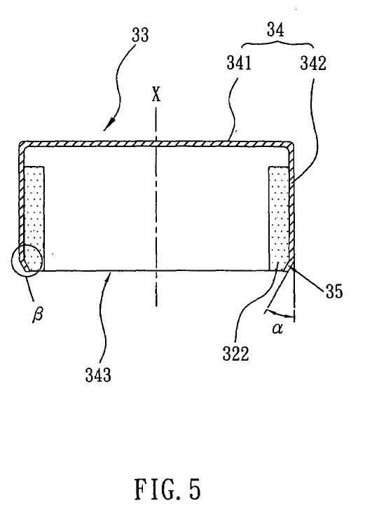

The above-mentioned first positioning structure 35 is only one example and should not be used to limit the scope of the present invention. For example, as shown in FIGS. 4 and 5, the first positioning structure 35 forms a predetermined angle “α” with respect to the side wall 342 of the body 34. That is, the retreated opening 343 is used to position the magnetic element 322. At the same time, the magnetic element 322 should be formed with a cutting angle “β”, corresponding to the predetermined angle “α” of the first positioning structure 35. That is, the slang angle of the magnetic element 322 matches with the retreated angle of the first positioning structure 35, so that the first positioning structure 35 can firmly hold the magnetic element 322.

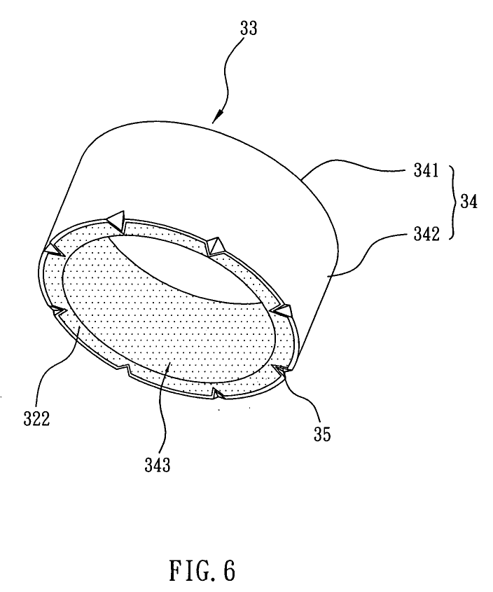

In addition to bending with an external force, one may also employ a stamping method. As shown in FIG. 6, the side wall 342 is directly stamped to form the first positioning structure 35. In this embodiment, the first positioning structure 35 can be stamped to have a triangular indentation or an indentation of another shape. The side of the magnetic element 322 far from the top surface 341 is also formed with an indentation structure corresponding to the first positioning structure 35, so that the first positioning structure 35 can firmly hold the magnetic element 322.

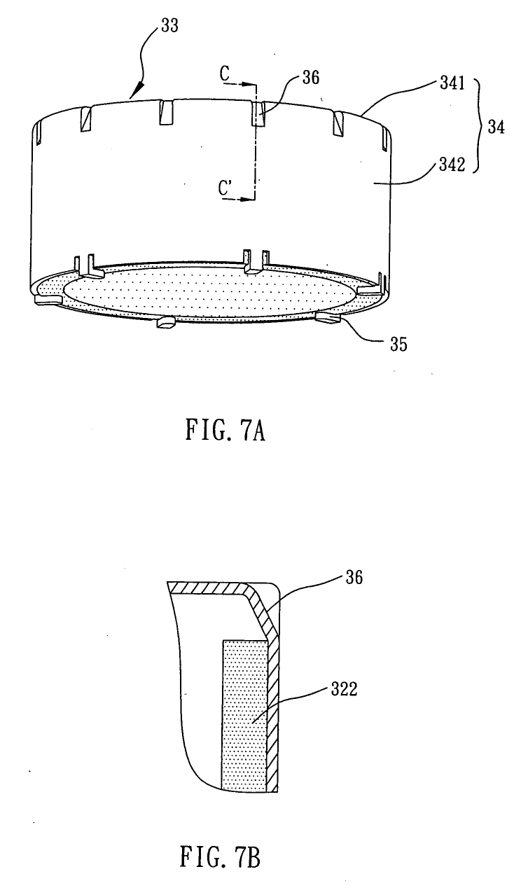

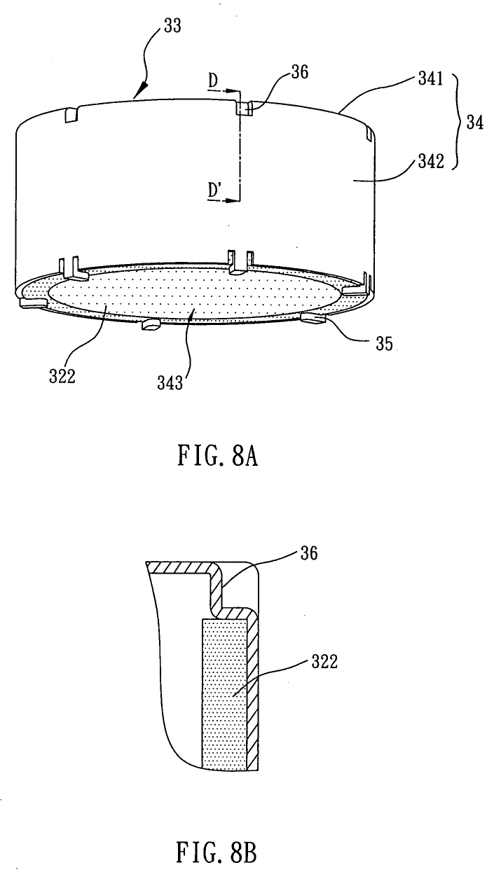

In addition to the first positioning structure 35, as shown in FIGS. 7A to 8B, the magnetic conducting housing 33 can have at least one second positioning structure 36 at the same time. FIG. 7B shows a partial cross-section along line C-C′ in FIG. 7A. FIG. 8B shows another partial cross-section along line D-D′ in FIG. 8A. In this embodiment, several second positioning structures 36 are located at a connection between the top surface 341 and the side wall 342 of the body 34 and are formed by stamping. The connection between the top surface 341 and the side wall 342 is formed with a slant angle (FIG. 7B) or a bending angle (FIG. 8B) for positioning the other end of the magnetic element 322. The first positioning structures 35 and the second positioning structures 36 provided on opposite sides of the magnetic element 322 provide firm positioning and increase the assembly efficiency.

In summary, the fan, the motor and the magnetic conducting housing thereof have a positioning structure disposed along a circumference of the magnetic conducting housing. Such a positioning structure can be formed along the side wall or by indenting the side wall, achieving the goal of holding the magnetic element. In comparison with the prior art, the disclosed positioning structure can indeed provide the positioning function and increase the assembly efficiency. Moreover, the present invention can prevent misalignment or department of the magnetic element after long-time use.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A magnetic conducting housing for a motor with a magnetic element disposed around its inner surface, the magnetic conducting housing comprising:
a body having a top surface and a side wall connected with a circumference of the top surface to form an opening; and
at least one first positioning structure extending from the side wall of the body and being close to the opening for holding the magnetic element.

2. A motor, comprising:
a stator;
a rotor having a magnetic element disposed corresponding to the stator; and
a magnetic conducting housing, comprising:
a body having a top surface and a side wall connected with a circumference of the top surface to form an opening, wherein the magnetic element is disposed around an inner surface of the side wall; and
at least one first positioning structure extending from the side wall of the body and being close to the opening for holding the magnetic element.

3. The motor of claim 2, wherein the first positioning structure is disposed along a circumference of the side wall and extends inwardly.

4. The motor of claim 2, wherein the first positioning structure has a predetermined angle with respect to the side wall.

5. The motor of claim 4, wherein the magnetic element has at least one cutting angle corresponding to the predetermined angle.

6. The motor of claim 5, wherein the cutting angle is formed at one side of the magnetic element far away from the top surface, whereby allowing the first positioning structure to firmly hold the magnetic element.

7. The motor of claim 2, wherein the magnetic conducting housing comprises a plurality of the first positioning structures, and the first positioning structures are hooks.

8. The motor of claim 2, wherein the first positioning structure has a semicircular, semielliptical, triangle, or polygonal profile.

9. The motor of claim 2, wherein the first positioning structure is formed by directly indenting the side wall or bending the side wall inwardly.

10. The motor of claim 2, wherein the first positioning structure is integrally formed with the side wall of the body, and extends inwardly to form as a L shape.

11. The motor of claim 2, wherein the first positioning structure and the body are two separate components to be combined.

12. The motor of claim 2, further comprising at least one second positioning structure which is located at a connection between the top surface and the side wall.

13. The motor of claim 12, wherein the second positioning structure is formed by stamping the connection between the top surface and the side wall.

14. The motor of claim 12, wherein the second positioning structure is a slant angle or a bending angle.

15. The motor of claim 2, wherein an adhesive glue is used between the magnetic element and the body to enhance combination effect.

16. The motor of claim 2, wherein the magnetic element is an annular magnetic strip or an annular permanent magnet.

17. The motor of claim 2, wherein the motor is an outer-rotor motor.

18. A fan, comprising:
an impeller; and
a motor connected to and driving the impeller to rotate, the motor comprising:
a stator;
a rotor having a magnetic element disposed corresponding to the stator; and
a magnetic conducting housing comprising a body and at least one first positioning structure, wherein the body has a top surface and a side wall connected with a circumference of the top surface to form an opening, the magnetic element is disposed around an inner surface of the side wall, and the first positioning structure extends from the side wall of the body and is close to the opening for holding the magnetic element.

19. The fan of claim 18, wherein the first positioning structure is disposed along a circumference of the side wall and extends inwardly, and the first positioning structure has a predetermined angle with respect to the side wall.

20. The fan of claim 18, wherein the magnetic conducting housing further comprises at least one second positioning structure which is located at a connection between the top surface and the side wall, and the second positioning structure is formed by stamping the connection between the top surface and the side wall.
